(19) United States
(12) Patent Application Publication
(10) Pub. No.: US 2007/0089604 A1
(43) Pub. Date: Apr. 26, 2007

(54) Novel chromatographic stationary phase

(76) Inventors: Wu Chen, Newark, DE (US); William E. Barber, Laudenberg, PA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/254,357

(22) Filed: Oct. 20, 2005

(51) Int. Cl. B01D 53/02

(52) U.S. Cl. 95/88; 96/101

(57) ABSTRACT

A composition of matter is provided comprising a metal oxide or metalloid oxide substrate, ⊕, having a surface that is covalently bonded to a silyl moiety according to Formula:
—Si(R¹)ₙ(X)ₘ(Y)_{q}
wherein R¹, X, m, n, Y and q are defined herein.

### BACKGROUND

Chromatography, for example liquid chromatography (LC), gas chromatography (GC) or supercritical fluid chromatography (SFC), is employed in both analytical and preparative methods to separate one or more species, e.g. chemical compounds, present in a carrier phase from the remaining species in the carrier phase. Chromatography is also employed, in a manner independent of separation of chemical species, as a method for analyzing purity of a chemical specie, and/or as a means of characterizing a single chemical specie. Characterization of a chemical specie may comprise data, for example, a retention time for a particular chemical compound, when it is eluted through a particular chromatography column using specified conditions, e.g., carrier phase composition, flow rate, temperature, etc.

The carrier phase, often termed the “mobile phase,” for LC typically comprises water and one or more water-miscible organic solvents, for example, acetonitrile or methanol. The carrier phase for SFC typically comprises supercritical carbon dioxide and, optionally, one or more organic solvents that are miscible therewith, e.g., an alcohol. The species typically form a solution with the carrier phase. The carrier phase is typically passed through a stationary phase.

Affinity of a specie for a stationary phase, which affects the rate at which a particular specie in a carrier phase passes through a stationary phase, results primarily from interaction of the specie with chemical groups present on the stationary phase. Chemical groups may be provided on the stationary phase by reacting a surface-modifying reagent with a substrate, such as a silica substrate. Surface-modifying agents may be employed to install desired chemical groups onto the stationary phase. For example, a suitable stationary phase for separating an anionic specie from a cationic specie may be prepared using a surface-modifying reagent to attach a cationic chemical group to a substrate surface thereby forming a stationary phase having cationic groups.

For polar species, a carrier phase comprising a high percentage of water, for example, greater than 95% water may be useful to effect separation of one or more of the species. Such conditions routinely cause conventional C8 and C18 stationary phases to demonstrate diminished retention properties over time, or to suddenly lose retention properties when the flow of the carrier phase is temporarily stopped. This loss in retention properties is commonly due to the phenomenon of hydrophobic phase collapse (hereinafter “phase collapse”). Phase collapse is believed to occur when the carbon chains of a stationary phase, such as C8 or C18 gradually cluster together when a carrier phase comprising a high percentage of water is passed through the stationary phase. Phase collapse is illustrated in FIG. 1(b).

Phase collapse significantly decreases the interaction between the stationary phase and the carrier phase. Carrier phases containing a high water percentage are also thought to be expelled from pores in the stationary phase, due to repulsion between the polar carrier phase and the hydrophobic stationary phase surface. The expulsion from pores is accelerated when pressure in a chromatography column drops, e.g., when the system pump, that supplies a flow of the carrier phase to the column, is stopped. FIG. 2 shows a pair of chromatograms, wherein chromatogram (a) was generated prior to phase collapse, and chromatogram (b) was generated subsequent to phase collapse precipitated by stopping the system pump for two minutes. Comparison of the two chromatograms in FIG. 2 provides an example of the loss of retention by a chromatography column resulting from stationary phase collapse.

Attempts have been made to design stationary phases resistant to phase collapse. For example non-endcapped, short-chain alkyl phases have been employed for LC with highly aqueous carrier phases. However, short chain stationary phases (carbon chains smaller than C4), provide little free volume between bonded chains and, accordingly, retention by the short chain stationary phase is less than with a conventional C18 stationary phase. Use of low bonding density C18 phases yields a stationary phase having reduced hydrophobicity and, accordingly, having diminished retention of polar compounds as compared to a conventional C18 stationary phase.

Polar enhanced stationary phases, such as hydrophilic endcapped and polar-embedded alkyl phases have also been employed to inhibit phase collapse. Hydrophilic endcapping increases polarity of the surface, which allows the surface to be wetted with water and fosters greater interaction between the carrier phase and the stationary phase. Polar-embedded alkyl phases contain a polar functional group, such as, an amide, ether, or carbamate in the alkyl group of the stationary phase and close to the substrate surface. The embedded polar group increases the interaction between the carrier phase and the stationary phase via hydrogen-bonding, thereby resulting in a layer of water on the substrate surface. In both hydrophilic endcapped and polar-embedded phases, selectivity is different from conventional C8 and C18 stationary phases. Polar end-capped phases and polar-embedded phases generally show reduced retention for polar species as compared to C8 and C18 stationary phases. Thus, methods developed using conventional C18 columns can generally not be transferred to such columns. Polar embedded phases are also thought to cause a higher dissolution rate of the silica support than conventional C8 and C18 stationary phases.

U.S. Pat. No. 6,241,891 describes the use of a stationary phase comprising straight chain alkyl groups having from 30-40 carbon atoms. The C30-C40 stationary phases were observed to be more resistant to phase collapse than C18 stationary phases. The stability of the C30-C40 stationary phase may relate to whether the stationary phase exists in a solid or in a liquid state under the conditions employed in the chromatography experiment. For example, a typical operating temperature of 30-40° C., though above the melting point of a C18 stationary phase (melting point of C₁₈H₃₈ is 29-30° C.), is below the melting point of a C30 stationary phase (melting point of C₃₀H₆₂ is 68-69° C.). Thus a C30 (triaconyl) stationary phase exists in a solid state at typical operating temperature. The longer chain stationary phase disclosed in U.S. Pat. No. 6,241,891 has been observed to demonstrate higher retention of both polar and nonpolar species than most polar-embedded and even high-coverage C18 phases. However, due to the large size of the ligand, the C30 phase is generally partially bonded, particularly when bonded to silica particles having a pore size less than 100 Å, so that the silica pores are not blocked.

Considerable research has been directed toward the development of new stationary phase compositions for use in chromatography. There remained, however, a need in the prior art to provide stationary phases, that provide separation of chemical species when a high water content carrier phase is employed for chromatographic separation.

### SUMMARY

According to one embodiment of the invention, there is provided a composition of matter comprising a metal oxide or metalloid oxide substrate, ⊕, the substrate having a surface that is covalently bonded to a silyl moiety according to Formula I:
—Si(R1)n(X)m(Y)q Formula I
wherein:

X is —(C₁-C₆)alkyl or —O(C₁-C₆) alkyl;

n is 1, 2 or 3;

m is 0, 1 or 2;

q is 0, 1 or 2;

the sum of n and m and q is 3;

Y is:
—[O—Si(R¹)ₙ*(X)ₘ*]ᵥA;

R¹ is a —(C₅-C₄₀)alkyl group comprising at least one cycloalkyl group, or a —(C₅-C₄₀)alkenyl group comprising at least one cycloalkyl group; wherein the at least one cycloalkyl group is optionally substituted by one or more substituents;

A is —OH or —O-⊕;

n* is 1 or 2;

m* is 0 or 1;

v is 0, 1, 2, 3, 4, 5, 6, 7, 8, 9 or 10;

the sum of n* and m* is 2;

provided that when q is other than 0, then the values for m and n for Formula I are equal to the values for m* and n*, respectively, for Y.

According to another embodiment of the invention, there is provided the above composition of matter for use in chromatography.

According to another embodiment of the invention, there is provided a method of performing a chromatographic separation of a plurality of chemical species in a mixture, the method comprising:

(a) providing a composition of matter comprising a metal oxide or metalloid oxide substrate, ⊕, said substrate having a surface that is covalently bonded to a silyl moiety according to Formula I:

(b) providing a carrier phase;

(c) passing the carrier phase through the column; and

(d) injecting the mixture into the carrier phase at a point prior to the carrier phase entering the column;

wherein the carrier phase is capable of eluting at least one species contained in the sample through the column.

According to another embodiment of the invention, there is provided a method of preparing a chromatographic stationary phase material comprising a metal oxide or metalloid oxide substrate, ⊕, said substrate having a surface that is covalently bonded to a silyl moiety according to Formula I:
—Si(R1)n(X)m(Y)q Formula I

(a) contacting, in a liquid medium, a metal oxide or metalloid oxide substrate, ⊕, with a silane compound according to Formula II:
Si(R1)n(X)m(L)g Formula II

wherein R¹, X, m and n are as defined for compounds of Formula I;

L is a reactive chemical group;

g is 1, 2 or3; and

the sum of n, m and g is 4; and

(b) isolating from said reaction mixture a composition of matter comprising said metal oxide or metalloid oxide substrate, ⊕, having a surface that is covalently bonded to the silyl moiety according to Formula I.

Additional aspects, advantages and novel features of the invention will be set forth in part of the Description, the Examples and the Figures which follow, all of which are intended to be for illustrative purposes only, and not intended in any way to limit the invention, and in part, will become apparent to those skilled in the art on examination of the following, or may be learned by practice of the invention.

### DESCRIPTION OF THE FIGURES

FIGS. 1(a) and 1(b) are drawings depicting conformational changes believed to occur in a C18 stationary phase in a phase collapse, wherein M is a substrate to which C18 groups are bonded. FIG. 1(a) depicts C18 groups in a dispersed conformation believed to exist in normal operation. FIG. 1(b) depicts C18 groups clustered together as is believed to occur as a result of phase collapse.

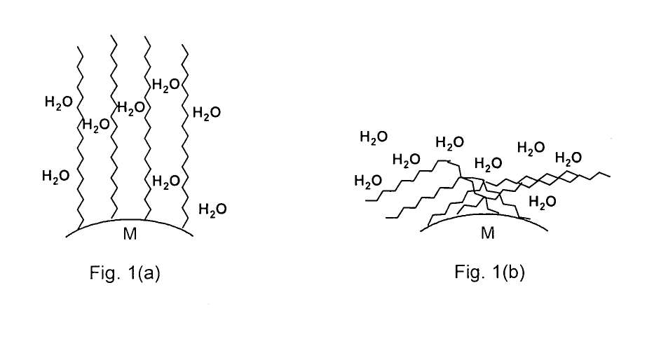

FIGS. 2(a) and 2(b) are chromatograms, wherein FIG. 2(a) shows the separation by a chromatography column (Rx 80 C18, 4.6×100 mm) using a carrier phase (50 mM phosphate in water) at a flow rate of 1.0 mL/min at 25° C., and the chromatogram of FIG. 2(b) shows the separation on the same chromatography column subsequent to stopping the system pump for two minutes. The chromatogram peaks (UV detector, 210 nm) correspond to the species: urea (1), procainamide (2), N-acetyl-procainamide (3), caffeine (4), and N-propionylprocainamide (5).

FIGS. 3(a) and 3(b) depict chromatograms, wherein FIG. 3(a) shows the separation by a chromatography column (cyclododecylsilyl, 4.6×100 mm) using a carrier phase (50 mM phosphate in water) at a flow rate of 1.0 mL/min at 25° C., and FIG. 3(b) shows the separation of the same species by the same chromatography column subsequent to stopping the system pump for two minutes. The chromatogram peaks (UV detector, 210 nm) correspond to the species: urea (1), procainamide (2), N-acetyl-procainamide (3), caffeine (4), and N-propionylprocainamide (5).

FIG. 4 shows graphically the differences observed between a conventional C18 stationary phase and the stationary phases of Example 1 (cyclohexyldimethylsilyl), Example 2 (cyclooctyldimethylsilyl) and Example 3 (cyclododecyldimethylsilyl) in the retention factor (K′) by each stationary phase for caffeine (1) and for N-propionylprocainamide (2), before and after a two-minute stopping of the system pump. The carrier phase is 50 mM phosphate in water, at a flow rate of 1.0 mL/min, at 25° C., and peak detection is by UV detector at 210 nm.

FIGS. 5(a) through 5(c) show three chromatograms that each record the separation of six species: oxalic acid (1), lactic acid (2), maleic acid (3), citric acid (4), succinic acid (5), and fumaric acid (6), using a 4.6×100 mm column, the carrier phase 50 mM phosphate in water, pH 2.5, a flow rate of 1 mL/min and a UV detector set at 215 nm. The chromatogram of FIG. 5(a) was generated using the stationary phase of Example 1 (cyclohexyldimethylsilyl), the chromatogram of FIG. 5(b) was generated using the stationary phase of Example 2 (cyclooctyldimethylsilyl), and chromatogram of FIG. 5(c) was generated using the stationary phase of Example 3 (cyclododecylsilyl).

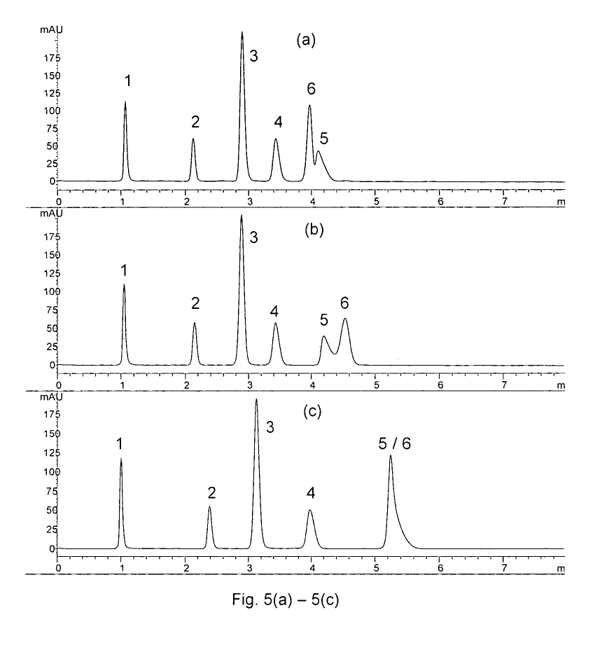

### DETAILED DESCRIPTION

A. Definitions

The term “alkyl,” by itself, or as part of another substituent, e.g., cyanooalkyl or aminoalkyl, means a hydrocarbon group, which is a saturated hydrocarbon radical having the number of carbon atoms designated (i.e., C₁-C₆ alkyl means the group contains one, two, three, four, five or six carbon atoms) and includes straight, branched chain, cyclic and polycyclic groups, for example, methyl, ethyl, propyl, isopropyl, butyl, isobutyl, tert-butyl, pentyl, neopentyl, hexyl, cyclohexyl, decyl, dodecyl, tetradecyl, octadecyl, norbornyl, and cyclopropylmethyl. Alkyl groups include, for example, —(C₁-C₄₀)alkyl, —(C₁-C₆)alkyl, —(C₃-C₂₀) alkyl and —(C₆-C₄₀)cycloalkyl.

The term “saturated,” with respect to an alkyl group, means that all of the carbon-carbon bonds in the group are carbon-carbon single bonds.

The term “alkenyl,” by itself, or as part of another substituent, e.g., alkenyl silane, means a hydrocarbon radical containing at least one carbon-carbon double bond and having the number of carbon atoms designated (i.e. C₁-C₆ alkenyl means the group contains one, two, three, four, five or six carbons). Alkenyl groups include straight, branched chain, cyclic and polycyclic groups. Examples include: vinyl, propenyl, and butenyl. Desirable alkenyl groups include, for example, —(C₅-C₄₀)alkenyl, and —(C₁-C₆)alkenyl, (C₅-C₂₀) alkenyl.

The term “cycloalkyl” refers to ring-containing alkyl radicals. Cycloalkyl groups may contain, for example, 1, 2 or 3 rings. For cycloalkyl groups containing more than one ring, i.e., polycyclic cycloalkyl groups, the rings may be fused, i.e., two rings share two or more adjacent ring atoms and the bonds connecting the two or more shared ring atoms, spiro-fused, i.e., two rings share one ring atom, or the rings may be connected in a pendent manner, i.e. one atom of one ring is bonded to one atom of a second ring, wherein the connecting bond may be a single bond or a double bond. Examples of a fused ring sharing two ring atoms (a), a fused ring sharing more than two ring atoms (b), a spiro-fused ring (c) and rings connected in a pendant manner (d) are depicted in Scheme 1.

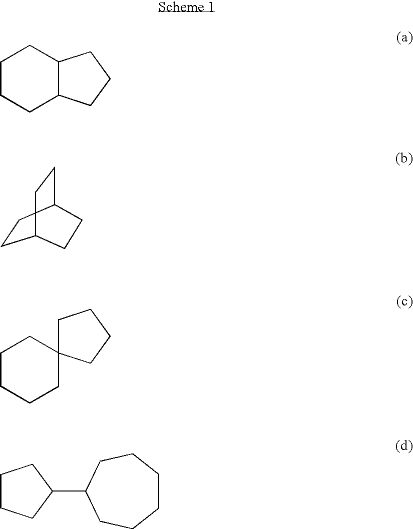

Examples of cycloalkyl groups include cyclohexyl, cycloheptyl, cyclooctyl, cyclononyl, cyclodecyl, cyclododecyl, cyclooctadecyl, cyclooctylethyl, norbornyl, decahydronaphthyl and tetradecahydroanthryl.

The term “alkylene,” by itself or as part of another substituent, means a divalent saturated hydrocarbon radical. For example, the expression “—C(═O)(C₁-C₄)alkylene-R” may include, for example, one, two, three or four carbon alkylene groups. A substitution of a group, such as R on an alkylene, may be at any substitutable carbon. For example, the group, —C(═O)(C₄ alkylene)R, includes, for example (a), (b) and (c), in Scheme 2, below:

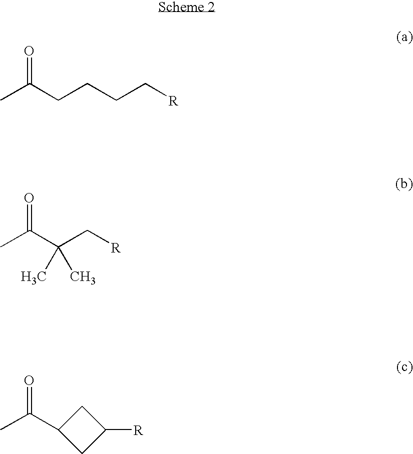

The expression “exocyclic carbon-carbon double bond” refers to a carbon-carbon double bond wherein one carbon of the double bond is a ring atom in a cycloalkyl ring, but the other carbon atom of the double bond is not a ring atom of the same ring. Examples include (a), (b) and (c) in Scheme 3 below.

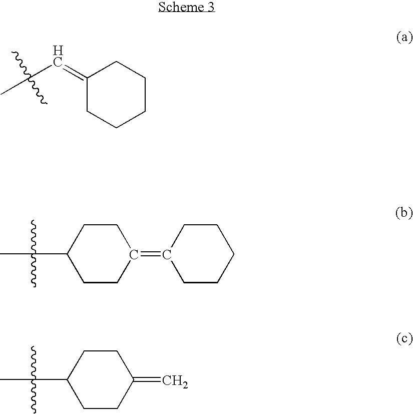

The term “substituted” means that a hydrogen atom attached to a group, e.g., a alkyl group, has been replaced by another atom, e.g. Cl, or group of atoms, e.g. CH₃. The term “substituted” refers to any level of substitution, for example, mono-, di, tri-, tetra-, or penta-substitution. Substituents are independently selected, and substitution may be at any position that is chemically and sterically accessible. Substituents include, or may be derived from, for example, alkyl; alkylene; halogen; —C(halogen)₃, for example —CF₃; —CN; —OH; —NO₂; —O(C₁-C₇)hydrocarbyl; oxo; epoxide; —S(C₁-C₇)hydrocarbyl; —SO(C₁-C₇)hydrocarbyl; —SO₂(C₁-C₇)hydrocarbyl-CO₂(C₁-C₇) hydrocarbyl; a cation exchanger, for example, —CO₂H or —SO₃H; an anion exchanger, for example, —NH₂, —NH(C₁-C₆)alkyl, or —N(C₁-C₆ alkyl)₂; —C(═O)NH₂; —C(═O)NH(C₁-C₇)hydrocarbyl; —C(═O)N((C₁-C₇)hydrocarbyl)₂; urea; peptide; protein; carbohydrate; nucleic acid; and mixtures thereof.

Where a substituent is alkyl or alkylene, it may be further substituted with one or more substituents independently selected from above.

The expression, “reactive chemical group” refers to a chemical group in a compound which group is, for example, nucleophilic or electrophilic, or a substrate for electrophilic addition reaction, such that the reactive chemical group is the chemical group directly involved in bond making or bond breaking in a chemical reaction of the compound. Examples of nucleophilic reactive chemical groups include primary and secondary amino groups, alcohol —OH groups, and thiol —SH groups. Examples of electrophilic reactive chemical groups include leaving groups. An example of a group that is a substrate for electrophilic addition is an olefin group, such as a vinyl group.

The expression “leaving group” refers to the chemical group that is displaced in a substitution or elimination reaction. Examples include halogen atoms, such as —Cl and —Br, and sulfonate moieties, such as mesyl, tosyl, nosyl, and trifyl.

The term “metal” refers to an element that is lustrous, ductile and generally electropositive, i.e., forms compounds in positive oxidation states, and that is a conductor of heat and electricity as a result of having an incompletely filled valence shell. The term, “metal oxide” refers to a chemical compound of oxygen with a metal, for example, tin oxide.

The term “metalloid” refers to an element, for example boron, or silicon which demonstrates properties which are intermediate between the properties of typical metals and typical nonmetals, i.e., has physical appearance and properties of a metal (as defined above), but behaves chemically as a non-metal. Elements classified as metalloids are in the periodic table in a diagonal block separating metals from nonmetals, and include, for example silicon, boron, arsenic, bismuth, germanium, antimony, and tellurium. The term, “metalloid oxide” refers to a chemical compound of oxygen with a metalloid, for example, silicon dioxide.

B. Silyl Groups of Formula I

Compositions according to an embodiment of the invention comprise a silyl moiety according to Formula I:
—Si(R1)n(X)m(Y)q (Formula I)

wherein:

X is —(C₁-C₆)alkyl or —O(C₁-C₆) alkyl;

n is 1, 2 or 3;

m is 0, 1 or 2;

q is 0, 1 or 2;

the sum of n and m and q is 3;

Y is:
—[O—Si(R¹)ₙ*(X)ₘ*]ᵥA;

R¹ is a —(C₅-C₄₀)alkyl group comprising at least one cycloalkyl group, or a —(C₅-C₄₀)alkenyl group comprising at least one cycloalkyl group; wherein the at least one cycloalkyl group is optionally substituted by one or two substituents which are —(C₁-C₄)alkyl, and which substituents are the same or different;

A is —OH or —O-⊕;

n* is 1 or 2;

m* is 0 or 1;

v is 0, 1, 2, 3, 4, 5, 6, 7, 8, 9 or 10;

the sum of n* and m* is 2;

provided that when q is other than 0, then the values for m and n for Formula I are equal to the values for m* and n*, respectively, for Y.

In silyl groups of Formula I, R¹ comprises, for example, a —(C₅-C₄₀)alkyl group containing at least one cycloalkyl group. The —(C₅-C₄₀)alkyl group containing at least one cycloalkyl group comprises, for example, a —(C₅-C₄₀)cycloalkyl group. A —(C₅-C₄₀)cycloalkyl group may be, for example, a monocyclic group or a polycyclic group, such as a bicyclic or tricyclic group.

The —(C₅-C₄₀)alkyl group containing at least one cycloalkyl group comprises, for example, a —(C₁-C₄)alkylene-(C₅-C₃₆)cycloalkyl group. The —(C₅-C₃₆)cycloalkyl part of a —(C₁-C₄)alkylene-(C₅-C₃₆)cycloalkyl group comprises, for example, a monocyclic group or a polycyclic group, for example, a bicyclic or tricyclic group.

According to some embodiments, the —(C₅-C₄₀)alkenyl group containing at least one cycloalkyl group comprises at least one —(C₅-C₃₆)cycloalkyl group, wherein the —(C₅-C₃₆)cycloalkyl group comprises at least one exocyclic carbon-carbon double bond.

The at least one cycloalkyl group may be selected, for example, from the group consisting of cyclohexyl, cycloheptyl, cyclooctyl, cyclononyl, cyclodecyl, cyclododecyl, cyclotetradecyl, cyclooctadecyl, bicyclo[2.2.2]octyl, bicyclo[2.2.1]heptyl, 4-t-butylcyclohexyl, 3,5-dimethylcyclohexyl, cyclo-hexylmethyl, 2-cyclohexylethyl, 2,2-dicyclohexylethyl, 4-(cyclohexyl)cyclohexyl, 4-((4-cyclohexyl)cyclohexyl)cyclohexyl, 1-decahydronaphthyl, 2-decahydro-naphthyl, 1-tetradecahydroanthryl, 2-tetradecahydroanthryl, 10-tetradeca-hydroanthryl, octahydro-1H-indenyl, 4-cyclohexylidenecyclohexyl and 4,4-(spiro-cyclohexyl)cyclohexyl.

The —(C₅-C₄₀)alkyl group containing at least one cycloalkyl group comprises, for example, a C₁-C₂₀ straight chain alkyl group that is substituted by one or more cyclohexyl groups, a C₂-C₂₀ straight chain alkyl group which is substituted by one or more cyclohexyl groups, a C₃-C₂₀ straight chain alkyl group which is substituted by one or more cyclohexyl groups, a C₄-C₂₀ straight chain alkyl group which is substituted by one or more cyclohexyl groups, a C₅-C₂₀ straight chain alkyl group which is substituted by one or more cyclohexyl groups, or a C₆-C₂₀ straight chain alkyl group which is substituted by one or more cyclohexyl groups. Substitution by one or more cyclohexyl groups comprises, for example, substitution by one, two, three or four cyclohexyl groups. According to an embodiment, no two cyclohexyl groups are attached to the same carbon of the straight chain alkyl group. According to another embodiment, substitution by one or more cyclohexyl groups comprises substitution of two cyclohexyl groups on the same carbon atom of the straight chain alkyl group, i.e. geminal substitution.

R¹ cycloalkyl groups, such as cyclohexyl groups, may be unsubstituted or substituted, for example, mono-, di, tri- or tetra-substituted. Substituted cyclohexyl groups on R¹ may be, for example, mono-substituted at the 2-, 3- or 4-position or di-substituted, for example, geminally di-substituted at the 2-position, the 3-position or the 4-position, or substituted at the 2- and 4-positions, or substituted at the 2- and 6-positions, or substituted at the 3- and 5-positions, or substituted at the 3- and 4-positions.

Substituents on R¹ cycloalkyl groups comprise, for example, methyl, ethyl, isopropyl and isobutyl groups.

Substituents on R¹ cycloalkyl groups may also be selected, for example, from the group consisting of halogen, for example, —F, —Cl and —Br; —CN; —OH; —NO₂; —O(C₁-C₇)hydrocarbyl, for example, —O(C₁-C₆)alkyl or —O-benzyl; oxo; epoxide; —SO₂(C₁-C₇)hydrocarbyl, for example, —SO₂(C₁-C₆)alkyl or —SO₂-benzyl, —SO(C₁-C₇)hydrocarbyl, for example, —SO(C₁-C₆)alkyl or —SO-benzyl, —S(C₁-C₇)hydrocarbyl, for example, —S(C₁-C₆)alkyl or —S-benzyl, —CO₂(C₁-C₇) hydrocarbyl, for example, —CO₂(C₁-C₆)alkyl or —CO₂-benzyl; a anion exchanger, for example, —CO₂H or —SO₃H; an cation exchanger, for example —NH₂, —NH(C₁-C₆)alkyl, —N(C₁-C₆ alkyl)₂ or —N⁺((C₁-C₅)alkyl)₃; —C(═O)NH₂; —C(═O)NH(C₁-C₇)hydrocarbyl, for example, —C(═O)NH(C₁-C₆)alkyl or —C(═O)NHbenzyl; —C(═O)N((C₁-C₇)hydrocarbyl)₂, for example, —C(═O)N((C₁-C₆)alkyl)₂ or —C(═O)N(C₁-C₆alkyl)benzyl; urea containing moieties; peptide radicals; and mixtures thereof.

Urea substituents on R¹ cycloalkyl groups may be independently selected, for example, from the group consisting of —NHC(═O)NH₂, —N(C₁-C₇)hydrocarbyl)C(═O)NH₂, —NHC(═O)NH(C₁-C₇)hydrocarbyl), —NHC(═O)N(C₁-C₇)hydrocarbyl)₂, —N(C₁-C₇)hydrocarbyl)C(═O) NH(C₁-C₇)hydrocarbyl), and —N(C₁-C₇)hydrocarbyl)C(═O)N(C₁-C₇)hydrocarbyl)₂).

Peptide substituents on R¹ cycloalkyl groups may comprise, for example, carboxy terminally-linked peptidyl residues containing 1, 2 or 3 amino acids, wherein the terminal amino group of the peptidyl residue is present as a chemical group, selected from the group consisting of —NH₂, —NHC(═O)(C₁-C₆)alkyl, —NH(C₁-C₆)alkyl, —N(C₁-C₆ alkyl)₂ and —NHC(═O)O(C₁-C₇)hydrocarbyl.

Peptide substituents on R¹ cycloalkyl groups may comprise, for example, amino terminally-linked peptidyl residues containing 1, 2 or 3 amino acids, wherein the terminal carboxyl group of the peptidyl residue is present as a chemical group, selected from the group consisting of —CO₂R^{p} and —C(═O)NR^{p}₂); wherein R^{p} is —H or —(C₁-C₇ hydrocarbyl), for example, benzyl or (C₁-C₆ alkyl).

The group X comprises, for example, —(C₁-C₆)alkyl, or —(C₁-C₃)alkyl, e.g., methyl, ethyl, isopropyl, t-butyl and neopentyl.

According to certain embodiments of the invention, n is 1, n* is 1, m is 2, m is 1, m* is 1, v is 1-10, 1-5, 1-3, or 1, and q is 0, wherein values for n, n*, m, m*, v and q are selected independently.

The substrate, ⊕, comprises a material selected from the group consisting of silica, hybrid silica, zirconia, titania, chromia, alumina, and tin oxide. According to some embodiments of the invention, the substrate comprises silica.

The substrate comprises, for example, particles of the metal oxide or metalloid oxide. Such particles of the metal oxide or metalloid oxide comprise, for example microspheres, such as, silica microspheres.

The substrate, ⊕, alternately comprises a solid material coated with metal oxide or metalloid oxide, for example silica.

According to an embodiment of the invention, the compositions disclosed herein are provided for use in chromatography. The composition for use in chromatography comprises the composition, for example, packed in a chromatography column or deposited onto a chromatography plate.

For the method of performing a chromatographic separation of a plurality of chemical species in a mixture, the carrier phase comprises, for example, at least 80% water, at least 90% water, at least 95% water, or at least 98% water.

C. The Substrate

Substrates useful in embodiments of the invention have a surface comprising chemical groups that are capable of reacting with a surface modifying reagent. For example, inorganic solids, such as silica or alumina, may be suitably chemically prepared, e.g., by hydrolysis, such that surface —OH groups are provided for reaction with a surface modifying reagent, for example, a silane reagent comprising a leaving group, for example a Si—Cl group.

The substrate surface may alternatively be derivatized to provide chemical groups other than an —OH group, which groups are reactive toward surface-modifying silane reagents that comprise a reactive moiety other than a leaving group. For example, the surface of silica substrate may be halogenated with a halogenating reagent, e.g., a chlorinating agent, for example, silicon tetrachloride or thionyl chloride. The resulting halogenated substrate surface, containing reactive Si—X groups, wherein X is a halogen, may then be reacted with silane reagents containing, for example, Si—OH groups to prepare the stationary phase compositions according to an embodiment of the invention.

The silica surface may alternatively be derivatized to provide —Si—H groups. Such Si—H groups may be reacted, for example, with an olefin, such as a vinyl group, in a hydrosilation reaction.

The substrate comprises, for example, a material selected from the group consisting of silica, hybrid silica, zirconia, titania, chromia, alumina and tin oxide. Hybrid silicas include materials where a portion of the Si atoms, or SiO groups have been replaced by other metal or metalloid atoms, such as W, Mg, Al, Zr, B or Ge. Alternatively, in hybrid silica, a portion of the Si—O bonds have been replaced by other moieties, such as hydrocarbyl or O-hydrocarbyl groups, hydrogen or other species, such as phosphorous. For example, a hybrid silica may include a fraction having the formula Si—O—Si—Y—Si—O or Si—OSi(Y)—O, where Y represents a metal, metalloid, hydrocarbyl or other species. According, in some embodiments of the invention the substrate comprises silica.

The substrate comprises, for example, particles of the metal oxide or metalloid oxide, for example, particles of silica. The substrate particles comprise, for example, microspheres, for example, silica microspheres.

Microspheres, such as silica microspheres, have an average diameter ranging, for example, from about 0.5 to about 50 microns, or from about 1 to about 30 microns, or from about 1 to about 15 microns. The expression “average diameter” means the statistical average of the spherical diameters of the microspheres.

Such microspheres, useful as substrates in the practice embodiments of the invention, are substantially uniform in size. As employed herein when referring to the size of silica microspheres, the expression, “substantially uniform in size,” means that less than about 5% of the microspheres have a diameter less than about 0.5 times the average diameter, and less than 5% have a diameter greater than 1.5 times the average microsphere diameter. According to some embodiments of the invention, less than about 5% of the microspheres have a diameter less than about 0.8 times the average microsphere diameter, and less than 5% have a diameter greater than 1.2 times the average microsphere diameter.

Microspheres, such as silica microspheres, useful as substrates in the practice of embodiments of the invention are porous or non-porous. Porous microspheres have controlled pore dimensions and a relatively large pore volume.

The size and shape of substrates useful in the practice of embodiments of the invention are variable. According to certain embodiments of the invention, the substrate comprises a solid material coated with a layer of a suitable metal oxide or metalloid oxide, for example, silica, which is capable of reacting with a suitable silane reagent. The substrate may in the alternative be provided in different shapes, such as spheres, irregularly shaped articles, rods, plates, films, sheets, fibers, or other massive irregularly shaped objects. For example, titania may be coated with a thin layer of silica, for example according to the method described by Iber (The Chemistry of Silica, John Wiley and Sons, New York, 1979, p. 86). Such a layer of silica may be prepared, e.g., by hydrolysis, and reacted with a suitable silane reagent.

D. Preparation of Compositions

According to certain embodiments the silane comprises Formula II:
Si(R1)n(X)m(L)g (Formula II)

wherein R¹, X, m and n are as defined for compounds of Formula I

L is a reactive chemical group; and

g is 1, 2, or 3; and

the sum of n, m and g is 4.

According to a selected embodiment, in the silane of Formula II, g is 1 or 2, while in another, the silane of Formula II, g is 1.

According to an embodiment, the reactive group, L, is a leaving group. A leaving group, L may be, for example, independently selected from the group consisting of halogen, for example, —F, —Cl and —Br; —O(C₁-C₆)alkyl, for example, —OCH₃ and —OC₂H₅; and —N((C₁-C₃)alkyl)₂, for example —N(CH₃)₂ and —N(C₂H₅)₂. According to another embodiment, the reactive group L may be an olefin, such as a vinyl group (Si—R—CH═CH₂).

When g is 1 in the silane according to Formula II, then q in the stationary phase compositions produced thereby, according to Formula I, is zero.

Accordingly, a silane reagent, such as cyclooctadecyldimethylsilyl-chloride, which has one reactive chemical group, e.g., a —Cl leaving group, reacts to form one bond to the substrate, ⊕, as shown Scheme 4 below.

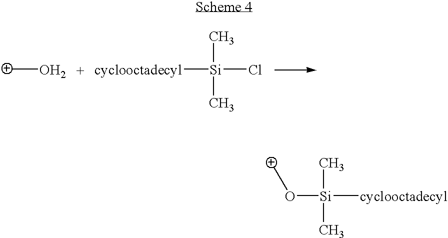

When g is 2 or 3 in the silane according to Formula II, then q in stationary phase compositions produced thereby according to Formula II, is respectively 1 or 2.

Accordingly, a silane reagent, such as cyclooctadecylmethysilyldi-chloride, which has two reactive chemical groups, e.g., —Cl leaving groups, may react to form one bond to the substrate, ⊕, as shown in Scheme 5 below. 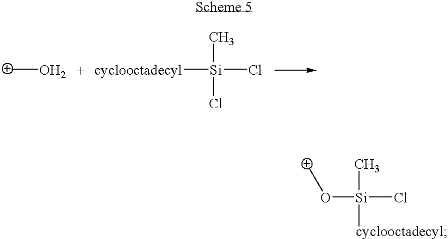
and still have a second reactive group, i.e., another chlorine leaving group, 10 available to react. The second reactive group in some instances, reacts to form a second bond to the substrate as shown in Scheme 6. However, bonding as shown in Scheme 6 is sterically and geometrically demanding.

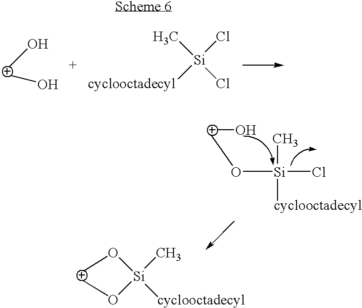

Less sterically demanding compositions are formed by reaction of the second reactive group with a hydrolysis product of the cyclooctadecylmethyl-silyldichloride or, alternatively, hydrolysis of the second reactive group and reaction of the resulting Si—OH hydrolysis product with an additional molecule of the cyclooctadecylmethylsilyldichloride. The result of this series of reactions is a polymerization comprising multiple divalent silyl units, in this instance: 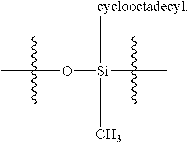
The polymerization may produce a vertical polymerization product if the growing polymeric chain is terminated by hydrolysis of the reactive group. Vertical polymerization is depicted in Scheme 7.

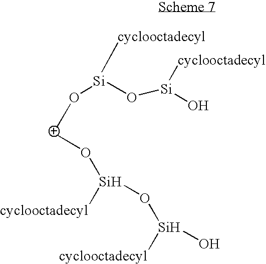

The polymerization may, in the alternative, produce a horizontal polymerization product if the growing polymeric chain is terminated by reaction of the reactive group on the growing polymeric chain with the substrate. Horizontal polymerization is depicted in Scheme 8, wherein v is an integer from 1 to about 10.

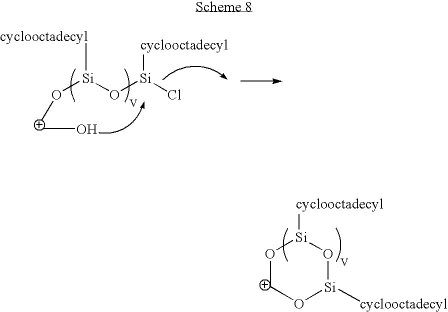

For a composition according to Formula I, horizontal polymerization is contemplated when q is other than 0 and A is:

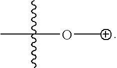

The symbol comprising “⊕” represents the same substrate particle at both attachment points in a compound of Formula I. Formation of a second bond to the substrate, ⊕, through one or more divalent (Si—O) units produces a composition according to Formula I, wherein q is 1 and v is the number of silane moieties through which the second bond is connected back to the substrate, ⊕.

The process, according to the present invention, of preparing a stationary phase composition comprises reaction of a silane of Formula II with a suitable substrate. Typically, the reaction may be performed in a suitable organic solvent or solvent mixture, for example, toluene, xylene, or mesitylene or a mixture thereof. A solvent or solvent mixture may further comprise a polar solvent, such as, for example, dimethylformamide or dimethylsulfoxide.

The reaction is typically performed at an elevated temperature, for example, from about 50° C., up to the reflux temperature of the solvent or solvent mixture, provided that the reaction temperature is not so high as to substantially degrade either the solvents or the reagents employed in the reaction over the duration of the reaction. The reaction is typically performed over a reaction time from about 12 hours to about 72 hours, or over a reaction time from about 24 hours to about 48 hours, or over a reaction time of about 24 hours.

The reaction is typically performed in the presence of an acid scavenger, for example an amine, such as, for example pyridine or imidazole. The acid scavenger is typically employed in a molar excess, for example greater than 1.1 equivalents based on the amount of a silane compound of Formula II. According to certain embodiments, an acid scavenger may be employed in from about 1.1 to about 5.0 equivalents, based on the amount of silane compound of Formula II. In certain embodiments, an acid scavenger that is a liquid, such as, for example, pyridine, may be employed as a solvent, or as one of several solvents in a solvent mixture involve in the process of preparing a stationary phase composition according to embodiments of the invention.

The composition produced by reacting a substrate with a Formula I silane may optionally be further reacted with an end-capping reagent. According to some embodiments of the invention, the end-capping reagent is a relatively small silane reagent, for example, XSiR^{e}₃, wherein X is a reactive chemical group, for example, a leaving group; and R^{e} may be substituted or unsubstituted —(C₁-C₆) alkyl. According to some embodiments, R^{e} may be unsubstituted —(C₁-C₆) alkyl, whereas in other embodiments, R^{e} may be unsubstituted —(C₁-C₃) alkyl, and still other, R^{e} may be methyl, ethyl, isopropyl, t-butyl or neopentyl. According to certain embodiments, R^{e} may be —(C₁-C₆) alkyl substituted by 1, 2 or 3 substituents independently selected from the group consisting of —CN, —CO₂H, —SO2OH, —NH₂, —NH(C₁-C₆)alkyl, —N((C₁C₆)alkyl)₂, and —N⁺((C₁-C₆)alkyl)₃. The endcapping reagent serves to react with reactive groups on the substrate surface, e.g., silanol groups on a silica substrate, that remain unreacted with the silane according to Formula II after the reaction therewith is completed.

E. Chromatography Tools Containing the Composition

Compositions according to the present invention may be employed in methods of separating chemical species by chromatography. For use in chromatography, compositions according to embodiments of the invention in a particulate form, may be, for example, packed into a chromatography column for industrial, analytical or preparatory equipment. Chromatography columns are produced in a variety of dimensions, which are based on the application that the particular column is used for. According to an embodiment of the invention, column dimension may be from about 0.1 to about 21.2 mm in diameter and from about 5 mm to about 250 mm in length. According to an embodiment of the invention column diameters may be from about 0.1 mm to about 9.4 mm. According to an embodiment of the invention column diameters may be from about 0.1 mm to about 4.6 mm. According to an embodiment of the invention column lengths range from 5 to 250 mm. According to an embodiment of the invention column lengths may range from 5 mm to 250 mm. According to an embodiment of the invention column lengths may also range from 20 mm to 150 mm. The chromatography column containing a composition according to embodiments of the invention may be operably connected to a reservoir containing a suitable carrier phase, and to a pump, for example, a mechanical or syringe pump, capable of pumping the carrier phase through the chromatography column, and to an injector capable of introducing one or more chemical species into the chromatography column. According to an embodiment of the invention the carrier phase may be pumped through the column at a rate of from about 0.1 mL/min. to about 20 mL/min. According to an embodiment of the invention, flow rates may range from 0.5 mL/min. to 5 mL/min., or 5 mL/min to 20 mL/min. According to an embodiment of the invention flow rates may also range from 1 mL/min. to 2 mL/min., or from 10 mL/min to 15 mL/min. The chromatography column containing a composition according to embodiments of the invention may further be operably connected to a detector, for example, an ultraviolet spectrophotometer, capable of detecting and optionally analyzing separated chemical species that are eluted from the chromatography column. The chromatography column containing a composition according to embodiments of the invention may further be operably connected to a fraction collector capable of collecting the carrier phase containing separated species in a plurality of separate containers, such that the separated species may be handled separately.

The composition according to an embodiment of the invention in a particulate form, may in the alternative, be deposited onto a chromatography plate, e.g., a thin layer chromatography plate or preparative thin layer chromatography plate. A chromatography plate comprises a layer of a material, for example, glass or a polymer film, onto which is deposited a chromatographic stationary phase.

A chromatography plate containing a composition according to an embodiment of the invention may be operably connected to a reservoir of a suitable mobile phase and/or to an injector capable of introducing chemical species onto the chromatography plate.

The composition according to an embodiment of the invention may alternately be employed in solid phase extraction (SPE) processes. For use in SPE processes, compositions according to embodiments the invention may be provided, for example, in SPE cartridges. The expression “solid phase extraction cartridge” is understood to include housings of various shapes, sizes and configurations which contain one or more stationary phase compositions according to embodiments the invention. SPE cartridges thus include, for example, cylindrical columns and disks. SPE cartridges include cartridges that are designed as disposable units and cartridges designed for repeated use. SPE cartridges include single cartridges and arrays of cartridges, for example ninety-six well plates. Passage of a carrier phase through a SPE cartridge may be performed, for example by employing a solvent pump to push the carrier phase through the SPE cartridge, or by application of vacuum to pull the carrier phase through the cartridge. The stationary phase compositions according to an embodiment of the invention, provided in a SPE cartridge, may be provided in amounts, for example, from about 25 mg to about 100 g per cartridge.

The instrumentation and techniques for using compositions according to an embodiment of the invention as described, for example, for chromatographic separations, including high performance liquid chromatography (HPLC), thin layer chromatography (TLC), flash chromatography, solid phase extraction and other forms of chromatographic separation, would be understood and employed by those skilled in the art.

The practice of the invention is illustrated by the following non-limiting examples.

### EXAMPLES

General Procedure: Materials: Type B Zorbax Rx-Sil silica support (Rx80) (surface area=180 m²/g, and pore size=80 angstroms) was obtained from Agilent Technologies, Inc., Wilmington, Del., and was dried under vacuum at 110° C. overnight before bonding.

### Example 1

### Preparation of Stationary Phase Comprising a Cyclohexyldimethylsilyl Group Bound to a Silica Substrate

The dried silica support prepared in the General Procedure above (21.80 g, 5 μm, surface area 172 m²/g), imidazole (5.40 g, 79.41 mmol) and toluene (110 mL) were charged into a four-necked 1000-mL flask, equipped with a mechanical stirrer, a condenser, a Barrette trap, and a thermometer. The resulting mixture was heated to the reflux temperature, and toluene (30 mL) was distilled out and collected in the Barrette trap. The temperature of the mixture was lowered to below the reflux temperature, and the Barrette trap was removed. Chlorodimethylcyclohexylsilane (7.99 g, 45.26 mmol) was added to the mixture. The resulting mixture heated to the reflux temperature and was stirred at the reflux temperature for 1 day. The mixture was filtered while still hot, washed with hot toluene, tetrahydrofuran (THF), methanol (MeOH), and acetonitrile (CH₃CN), and dried at 110° C. under vacuum overnight, thereby providing a stationary phase comprising a cyclohexyldimethylsilyl group bound to a silica substrate.

### Example 2

### Preparation of Stationary Phase Comprising a Cyclooctyldimethylsilyl Group Bound to a Silica Substrate

The dried silica support (11.75 g, 5 μm, surface area 172 m²/g), imidazole (1.65 g, 24.26 mmol) and toluene (70 mL) were charged into a four-necked 500 mL flask, equipped with a mechanical stirrer, a condenser, a Barrette trap, and a thermometer. The resulting mixture was heated to the reflux temperature, and toluene (30 mL) was distilled out and collected in the Barrette trap. The temperature of the mixture was lowered to below the reflux temperature, and the Barrette trap was removed. Chlorodimethylcyclooctyl-silane (3.31 g, 16.17 mmol) was added to the mixture. The resulting mixture heated to the reflux temperature and was stirred at the reflux temperature for 1 day. The mixture was filtered while still hot, washed with hot toluene, THF, MeOH, and CH₃CN, and dried at 110° C. under vacuum overnight, thereby providing a stationary phase comprising a cyclooctyldimethylsilyl group bound to a silica substrate.

### Example 3

### Preparation of Stationary Phase Comprising a Cyclododecyldimethylsilyl Group Bound to a Silica Substrate

The dried silica support (11.00 g, 5 μm, surface area 172 m²/g), imidazole (1.54 g, 22.70 mmol) and toluene (70 mL) were charged into a four-necked 500 mL flask, equipped with a mechanical stirrer, a condenser, a Barrette trap, and a thermometer. The resulting mixture was heated to the reflux temperature, and toluene (30 mL) was distilled out and collected in the Barrette trap. The temperature of the mixture was lowered to below the reflux temperature, and the Barrette trap was removed. Chlorodimethylcyclododecyl-silane (3.94 g, 15.14 mmol) was added to the mixture. The resulting mixture heated to the reflux temperature and was stirred at the reflux temperature for 1 day. The mixture was filtered while still hot, washed with hot toluene, THF, MeOH, and CH₃CN, and dried at 110° C. under vacuum overnight, thereby providing a stationary phase comprising a cyclododecyldimethylsilyl group bound to a silica substrate.

### Example 4

### Preparation of Stationary Phase Comprising a 2,2-dicyclohexylethyldimethylsilyl Group Bound to a Silica Substrate

### A. Preparation of chloro(dicyclohexylethyidimethylsilane

A mixture of chlorodimethylsilane (15.68 g, 165.9 mmol) and H₂PtCl₆ (0.18 g) was heated to reflux temperature. To the refluxing mixture was added, amount was added 1,1-dicyclohexylethene (22.75 g, 118.5 mmol), wherein a small amount (about 0.5 g) of the small amount of the 1,1-dicyclohexylethene was added, and the resulting mixture stirred at reflux temperature until the solution became dark brown, and then the remaining 1,1-dicyclohexylethene was added dropwise. The resulting mixture was maintained at reflux temperature for 2 hours after completion of the addition of 1,1-dicyclohexyl-ethene. The product was isolated by distillation from the reaction mixture under vacuum (0.15 mm Hg) at 120-125° C., thereby obtaining 26.88 g (yield 79.2%) of the desired chloro(dicyclohexylethyl)dimethylsilane.

### B. Preparation of Stationary Phase Comprising 2,2-(dicyclohexyl-ethyl)dimethylsilyl Group Bound to a Silica Substrate

The dried silica support (20.00 g, 5 μm, surface area 183 m²/g), imidazole (3.00 g, 43.92 mmol) and toluene (100 mL) were charged into a four-necked 1000 mL flask, equipped with a mechanical stirrer, a condenser, a Barrette trap, and a thermometer. The resulting mixture was heated to the reflux temperature, and toluene (30 mL) was distilled out and collected in the Barrette trap. The temperature of the mixture was lowered to below the reflux temperature, and the Barrette trap was removed.

Chloro(dicyclohexylethyl)dimethylsilane (8.39 g, 29.28 mmol) was added to the mixture. The resulting mixture heated to the reflux temperature and was stirred at the reflux temperature for 1 day. The mixture was filtered while still hot, washed with hot toluene, THF, MeOH, and CH₃CN, and dried at 110° C. under vacuum overnight, thereby providing a stationary phase comprising a 2,2-dicyclohexylethyidimethylsilyl group bound to a silica substrate.

### Example 5

### Performance of Stationary Phases Under Conditions Likely to Cause Phase Collapse

A. Preparation of Chromatography Columns Containing Stationary Phases of Examples 1, 2 and 3.

The stationary phase, as prepared in Examples 1, 2 and 3 was packed into columns (4.6×100 mm) by a slurry packing method under high pressure (above 8,000 psi).

B. Operation of Prepared Columns of Step A, and a Conventional C18 Column (Rx80 C18 4.6×100 mm) were Evaluated Under Each of the Following Adverse Conditions, Likely to Cause Phase Collapse:

1) Columns were purged with MeOH (100%, 20 minutes).

2) Columns were purged with 50% MeOH/50% 50 mM aqueous phosphate solution (pH 3.5) for 20 minutes.

3) Columns were purged with 10% MeOH/90% 50 mM aqueous phosphate solution (pH 3.5) for 20 minutes.

4) A test mixture was injected onto the column and eluted with 10% MeOH/90% 50 mM aqueous phosphate solution (pH 3.5), and the separation of the mixture was recorded as a chromatogram.

5) Columns were purged with 100% 50 mM aqueous phosphate solution (pH 3.5) for 20 minutes.

6) The pump was stopped for 2 minutes.

7) Columns were purged with 10% MeOH/90% 50 mM aqueous phosphate solution (pH 3.5) for 20 minutes.

8) A test mixture was injected onto the column and eluted with 10% MeOH/90% 50 mM aqueous phosphate solution (pH 3.5), and the separation of the mixture was recorded as a chromatogram.

The test mixture was a mixture of urea (as T₀ marker), procainamide, N-acetyl-procainamide, caffeine, and N-propionyl-procainamide.

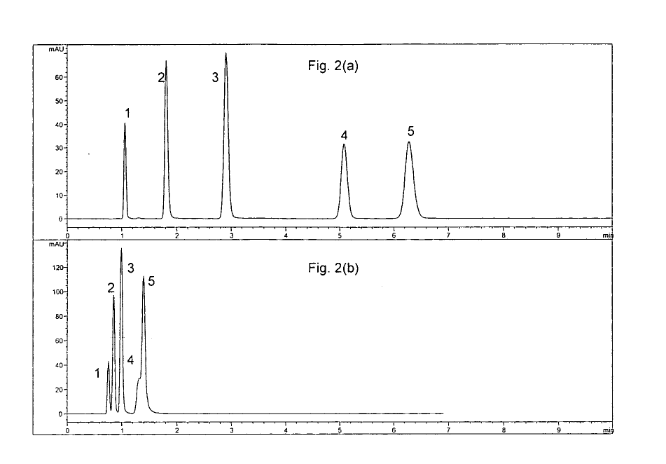

Chromatograms that were generated prior to stopping the pump, and again after restarting the pump, are reproduced in FIG. 2, wherein the column contains a conventional C18 stationary phase (Rx 80 C18 4.6×100 mm column). Dramatic change is observed in the separation obtained prior to stopping the pump (a) compared to the separation obtained after stopping the pump (b). The substantial decreases in the retention time of the components in the test mixture are believed to be caused by the occurrence of phase collapse in the C18 stationary phase, resulting from the stopping of the pump.

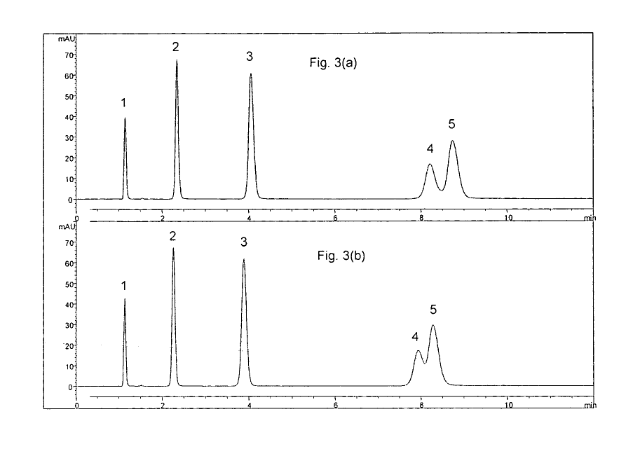

Chromatograms generated prior to stopping the pump, and again after restarting the pump, are reproduced in FIG. 3, wherein the column contains the stationary phase of Example 3. Little change is observed in the separation obtained prior to stopping the pump (a) compared to the separation obtained after stopping the pump (b) when using the stationary phase composition of Example 3.

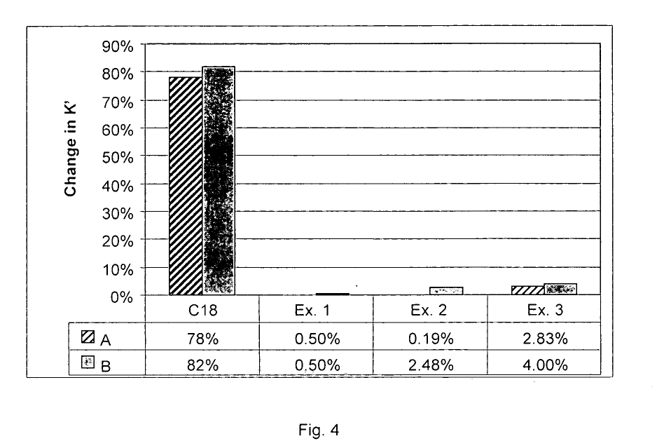

The decrease in K′ for two of the components of the test mixture, caffeine and N-propionyl procainamide, are shown as a bar graph in FIG. 4 for the separation on a conventional C18 column (Rx 80 C18 4.6×100 mm column) and for columns containing the stationary phase compositions of Example 1, Example 2 and Example 3. The decrease in K′ for caffeine and N-propionyl procainamide is 78% and 82% respectively, on a conventional C18 column, while the stationary phases of Examples 1, 2 and 3 demonstrate decreases in K′ of 4% or less. The substantial decrease in K′ for caffeine and N-propionyl procainamide for the chromatographic experiments on the conventional C18 column is believed to be due to substantial phase collapse that occurred as a result of the stopping of the pump.

### Example 6

### Performance of Stationary Phases under Conditions Likely to Cause Phase Collapse

A. The Columns Employed for Example 6 are the Columns Containing the Stationary Phase Compositions of Examples 1, 2 and 3, as Described in Example 5, and a Conventional C18 Column (Rx 80 C18 4.6×100 mm).

B. Operation of Chromatography Columns was Evaluated as Follows Under 100% Aqueous Conditions:

1) Columns were purged with MeOH (100%, 20 minutes).

2) Columns were purged with 50% MeOH/50% 50 mM aqueous phosphate solution (pH 3.5) for 20 minutes.

3) Columns were purged with 10% MeOH/90% 50 mM aqueous phosphate solution (pH 3.5) for 20 minutes.

4) Columns were purged with 100% 50 mM aqueous phosphate solution (pH 2.5) for 20 minutes.

5) A test mixture was injected onto the column and eluted with 100% 50 mM aqueous phosphate solution (pH 2.5), and the separation of the mixture was recorded as a chromatogram.

The test mixture consists of urea (as T₀ marker), oxalic acid, lactic acid, maleic acid, citric acid, succinic acid, and fumaric acid.

Chromatograms were generated for separations of the test mixture on columns containing the stationary phase compositions of Examples 1, 2 and 3. The mixture of organic acids was well retained on the stationary phases of Examples 1, 2 and 3. Thus, the stationary phases of Examples 1, 2 and 3 were shown to maintain retention capability under conditions, including use of a 100% aqueous carrier phase, conditions that were selected as likely to produce hydrophobic collapse in conventional stationary phase compositions.

The present invention may be embodied in other specific forms without departing from the spirit or essential attributes thereof. Accordingly, reference should be made to the appended claims, rather than to the foregoing specification, as indication of the scope of the invention.

What is claimed is:

1. A composition of matter comprising a metal oxide or metalloid oxide substrate, ⊕, the substrate having a surface that is covalently bonded to a silyl moiety according to Formula I:
—Si(R¹)ₙ(X)ₘ(Y)_{q} Formula I
wherein:
X is —(C₁-C₆)alkyl or —O(C₁-C₆) alkyl;
n is 1, 2 or3;
m is 0, 1 or 2;
q is 0, 1 or 2;
the sum of n and m and q is 3;
Y is:
—[O—Si(R¹)ₙ*(X)ₘ*]v_{A};
R¹ is a —(C₅-C₄₀)alkyl group comprising at least one cycloalkyl group, or a —(C₅-C₄₀)alkenyl group comprising at least one cycloalkyl group;
A is —OH or —O-⊕;
n* is 1 or 2;
m* is O or 1;
v is 0, 1, 2, 3, 4, 5, 6, 7, 8, 9 or 10;
the sum of n* and m* is 2;
provided that when q is other than 0, then the values for m and n for Formula I are equal to the values for m* and n*, respectively, for Y.

2. The composition according to claim 1, wherein m is 2, n is 1 and q is 0.

3. The composition according to claim 1, wherein the at least one cycloalkyl group is substituted by one or two substituents which are substituted or unsubstituted —(C₁-C₄)alkyl, and which substituents are the same or different.

4. The composition according to claim 1, wherein the at least one cycloalkyl group is substituted by at least one substituent selected from the group consisting of: halogen; —C(halogen)₃; —CN; —OH; —NO₂; —O(C₁-C₇)hydrocarbyl; oxo; epoxide; —S(C₁-C₇)hydrocarbyl; —SO(C₁-C₇)hydrocarbyl; —SO₂(C₁-C₇)hydrocarbyl; —CO₂(C₁-C₇)hydrocarbyl; —CO₂H; —SO₃H; an —NH₂; —NH(C₁-C₆)alkyl; —N(C₁-C₆alkyl)₂; —C(═O)NH₂; —C(═O)NH(C₁-C₇)hydrocarbyl; —C(═O)N((C₁-C₇)hydrocarbyl)₂; urea; peptide; protein; carbohydrate; nucleic acid; and mixtures thereof.

5. The composition according to claim 2, wherein X is —CH₃.

6. The composition according to claim 1, wherein R¹ comprises a C₁-C₂₀ straight chain alkyl group to which is bonded at least one cyclohexyl group wherein the cyclohexyl group.

7. The composition according to claim 1, wherein R¹ comprises a (C₅-C₄₀) cyclic alkyl group.

8. The composition according to claim 7, wherein the cyclic alkyl group is selected from the group consisting of cyclohexyl, cycloheptyl, cyclooctyl, cyclononyl, cyclodecyl, cyclododecyl, cyclotetradecyl, cyclooctadecyl, bicyclo[2.2.2]octyl, bicyclo[2.2.1]heptyl, 4-t-butylcyclohexyl, 3,5-dimethylcyclohexyl, cyclohexylmethyl, 2-cyclohexylethyl, 2,2-dicyclohexylethyl, 4-(cyclohexyl)cyclohexyl, 4-((4-cyclohexyl)cyclohexyl)cyclohexyl, 1-decahydronaphthyl, 2-decahydro-naphthyl, 1-tetradecahydroanthryl, 2-tetradecahydroanthryl, 10-tetra-decahydroanthryl, octahydro-1H-indenyl, 4-cyclohexylidenecyclohexyl and 4,4-(spiro-cyclohexyl)cyclohexyl.

9. The composition according to claim 1, wherein the substrate comprises a material selected from the group consisting of silica, hybrid silica, zirconia, titania, alumina, chromia and tin oxide.

10. The composition according to claim 9, wherein the substrate is particulate.

11. The composition according to claim 10, wherein the particulate substrate comprises microspheres.

12. The composition according to claim 10, wherein the particulate substrate comprises silica.

13. A chromatography column comprising a stationary phase, wherein the stationary phase further comprises the composition according to claim 1.

14. A chromatography column comprising a stationary phase, wherein the stationary phase further comprises the composition according to claim 6.

15. A chromatography column comprising a stationary phase, wherein the stationary phase further comprises the composition according to claim 7.

16. A chromatography column comprising a stationary phase, wherein the stationary phase further comprises the composition according to claim 8.

17. A chromatography plate comprising a stationary phase, wherein the stationary phase further comprises the composition according to claim 1.

18. A solid phase extraction cartridge comprising a stationary phase, wherein the stationary phase further comprises the composition according to claim 1.

19. A solid phase extraction cartridge comprising a stationary phase, wherein the stationary phase further comprises the composition according to claim 4.

20. A solid phase extraction cartridge comprising a stationary phase, wherein the stationary phase further comprises the composition according to claim 7.

21. A method of performing a chromatographic separation of a plurality of chemical species in a mixture, comprising:
(a) providing a composition of matter comprising a metal oxide or metalloid oxide substrate, ⊕, said substrate having a surface that is covalently bonded to a silyl moiety according to Formula I:
—Si(R¹)ₙ(X)ₘ(Y)_{q} Formula I
wherein:
X is —(C₁-C₆)alkyl or —O(C₁-C₆) alkyl;
n is 1, 2 or 3;
m is 0, 1 or 2;
q is 0, 1 or 2;
the sum of n and m and q is 3;
Y is:
—[O—Si(R¹)ₙ*(X)ₘ*]ᵥA;
R¹ is a —(C₅-C₄₀)alkyl group comprising at least one cycloalkyl group, or a —(C₅-C₄₀)alkenyl group comprising at least one cycloalkyl group;
wherein the at least one cycloalkyl group is optionally substituted by one or two substituents which are —(C₁-C₄)alkyl, and which substituents are the same or different;
A is —OH or —O-⊕;
n* is 1 or 2;
m* is 0 or 1;
v is 0, 1, 2, 3,4, 5, 6, 7, 8, 9 or 10;
the sum of n* and m* is 2;
provided that when q is other than 0, then the values for m and n for Formula I are equal to the values for m* and n*, respectively, for Y;
(b) providing a carrier phase;
(c) passing the carrier phase through the column; and
(d) injecting the mixture into the carrier phase at a point prior to the carrier phase entering the column;
wherein the carrier phase is capable of eluting at least one species contained in the sample through the column.

22. The method according to claim 21, wherein the carrier phase comprises at least 80 percent water.

23. The method according to claim 22, wherein the carrier phase comprises at least 90 percent water.

24. The method according to claim 23, wherein the carrier phase comprises at least 95 percent water.

25. The method according to claim 24, wherein the carrier phase comprises at least 98 percent water.

26. A method of preparing a chromatographic stationary phase material comprising a metal oxide or metalloid oxide substrate, ⊕, said substrate having a surface that is covalently bonded to a silyl moiety according to Formula I:
—Si(R¹)ₙ(X)ₘ(Y)_{q} Formula I
wherein:
X is —(C₁-C₆)alkyl or —O(C₁-C₆) alkyl;
n is 1, 2 or 3;
m is 0, 1 or 2;
q is 0, 1 or2;
the sum of n and m and q is 3,
Y is:
—[O—Si(R¹)ₙ*(X)ₘ*]ᵥA;
R¹ is a —(C₅-C₄₀)alkyl group comprising at least one cycloalkyl group, or a —(C₅-C₄₀)alkenyl group comprising at least one cycloalkyl group;
A is —OH or —O-⊕;
n* is 1 or 2;
m* is O or 1;
v is 0, 1, 2, 3, 4, 5, 6, 7, 8, 9 or 10;
the sum of n* and m* is 2;
provided that when q is other than 0, then the values for m and n for Formula I are equal to the values for m* and n*, respectively, for Y;
the method comprising:
(a) contacting, in a liquid medium, a metal oxide or metalloid oxide substrate, ⊕, with a silane compound according to Formula II:
Si(R¹)ₙ(X)ₘ(L)_{g} Formula II
wherein R¹, X, m and n are as defined above;
L is a reactive chemical group;
g is 1, 2 or 3; and
the sum of n, m and g is 4; and
(b) isolating from said reaction mixture a composition of matter comprising said metal oxide or metalloid oxide substrate, ⊕, having a surface that is covalently bonded to the silyl moiety according to Formula I.

27. The method according to claim 26, wherein the at least one cycloalkyl group is substituted by one or two substituents which are —(C₁-C₄)alkyl, and which substituents are the same or different.

28. The method according to claim 26, wherein the at least one cycloalkyl group is substituted by a substituent selected from the group consisting of: halogen; —C(halogen)₃; —CN; —OH; —NO₂; —O(C₁-C₇)hydrocarbyl; oxo; epoxide; —S(C₁-C₇)hydrocarbyl; —SO(C₁-C₇)hydrocarbyl; —SO₂(C₁-C₇)hydrocarbyl; —CO₂(C₁-C₇)hydrocarbyl; —CO₂H; —SO₃H; an —NH₂; —NH(C₁-C₆)alkyl; —N(C₁-C₆alkyl)₂; —C(═O)NH₂; —C(═O)NH(C₁-C₇)hydrocarbyl; —C(═O)N((C₁-C₇)hydrocarbyl)₂; urea; peptide; protein; carbohydrate; nucleic acid; and mixtures thereof.
